(19) United States
(12) Patent Application Publication
(10) Pub. No.: US 2025/0321904 A1
(43) Pub. Date: Oct. 16, 2025

(54) DYNAMIC DATA LOCALIZATION

(71) Applicant: Intel Corporation, Santa Clara, CA (US)

(72) Inventors: Akhilesh Thyagaturu, Ruskin, FL (US); Gurpreet Singh Kalsi, Portland, OR (US); Karthik Kumar, Chandler, AZ (US)

(73) Assignee: Intel Corporation, Santa Clara, CA (US)

(21) Appl. No.: 19/253,156

(22) Filed: Jun. 27, 2025

(51) Int. Cl. G06F 13/16; G06F 13/42

(52) U.S. Cl. CPC G06F 13/1668; G06F 13/42

(57) ABSTRACT

An application workload is performed on data by a plurality of processor devices, where the data is stored in a first memory associated with a first one of the processor devices and a second memory is associated with a second one of the processor devices. Accesses of the data from the first memory by the plurality of processor devices are monitored. The data is transformed from a first form to a second form based on the accesses, and the data is transformed in the second form to the second memory based on the accesses.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram of an example system implementing I/O virtualization.

FIG. 3 is a simplified block diagram illustrating an example computing system.

FIG. 4 is a simplified block diagram illustrating an example computing system including an enhanced data movement accelerator.

FIG. 5 is a block diagram illustrating example memory accesses and data locality management in an example system.

FIG. 6 is a simplified block diagram illustrating data locality management within an example computing system.

FIG. 7 is a flow diagram illustrating example data locality management for an application within an example computing system.

FIG. 8 illustrates a block diagram of an example processor device in accordance with certain embodiments.

Like reference numbers and designations in the various drawings indicate like elements.

### DETAILED DESCRIPTION

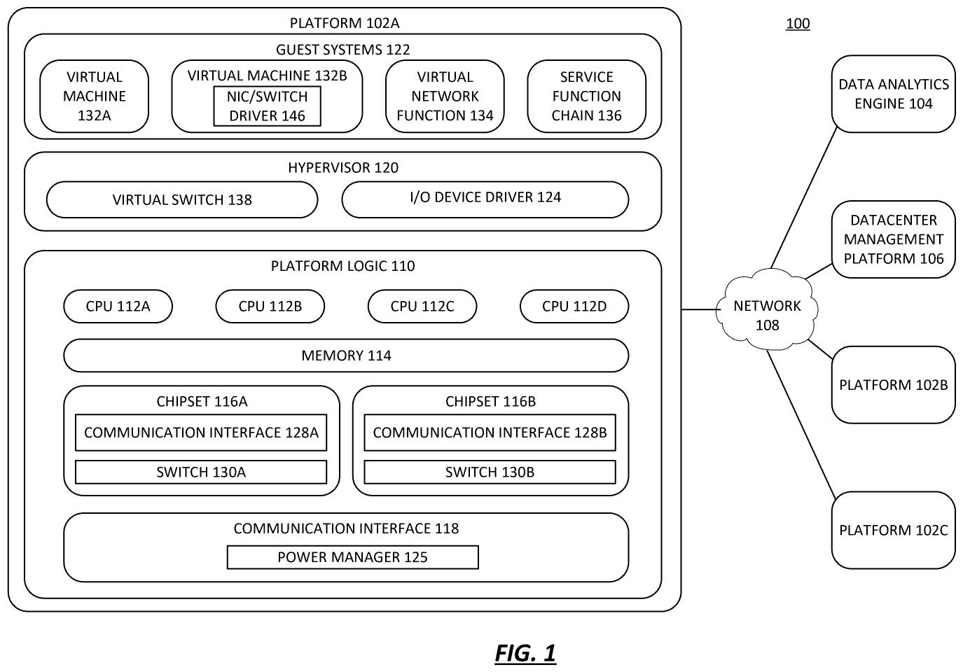

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters and these clusters may be enhanced through specialized networking accelerators and the use of Compute Express Link (CXL) memory semantics to make such cluster more efficient, among other example enhancements.

A platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removeably coupled to platform 102. Although four CPUs are shown, a platform 102 may include any suitable number of CPUs. In some implementations, application to be executed using the CPU (or other processors) may include physical layer management applications, which may enable customized software-based configuration of the physical layer of one or more interconnect used to couple the CPU (or related processor devices) to one or more other devices in a data center system.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. A chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on the respective CPUs.

Chipsets 116 may include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104 (which may be used with or incorporate a data movement accelerator, such as discussed below)). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. A platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform. Further implementations may be supported, such as set forth above, for enhanced I/O virtualization. A host operating system may identify conditions and configurations of a system and determine that features (e.g., SIOV-based virtualization of SR-IOV-based devices) may be enabled or disabled and may utilize corresponding application programming interfaces (APIs) to send and receive information pertaining to such enabling or disabling, among other example features.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports). In some implementations, I/O virtualization may be supported within the system and utilize the techniques described in more detail below. I/O devices may support I/O virtualization based on SR-IOV, SIOV, among other example techniques and technologies.

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

Single Root I/O Virtualization (SR-IOV) is a PCI-SIG defined specification for hardware-assisted I/O virtualization that defines a standard way for partitioning endpoint devices for direct sharing across multiple VMs or containers. An SR-IOV capable endpoint device provides a Physical Function (PF) and multiple Virtual Functions (VFs). The PF of a device in SR-IOV provides resource management for the device and is managed by a host driver running in the host operating system (OS). A provided VF can be assigned to a VM or container for direct access. SR-IOV-capable devices may provide high performance I/O, including I/O devices such as network and storage controller devices as well as programmable or reconfigurable devices such as GPUs, FPGAs, and other accelerators, among other examples.

Scalable IOV (SIOV) also seeks to define an approach for the virtualization of I/O, for instance, within a data center. SIOV provides hardware-assisted I/O virtualization that enables a higher degree of scalability and performance in the sharing of I/O devices across isolated domains (e.g., VMs and containers). In SIOV, flexible composition of virtual devices for device sharing is enabled. Accesses between a VM and a virtual device are defined in SIOV as either a “direct path” access or an “intercepted path” access. Direct-path operations on the virtual device are mapped directly to the underlying device hardware for performance, while intercepted-path operations are emulated at least partially in software by a Virtual Device Composition Module (VDCM) to enable this greater flexibility in I/O virtualization. Which operations and accesses are processed as intercepted path versus direct path may vary depending on the device implementation and application. For instance, slow-path operations (e.g., initialization, control, configuration, management, QoS, error processing, and reset) are treated as intercepted-path accesses and fast-path operations (e.g., work submission and work completion processing) are treated as direct-path accesses, among other examples.

Similar to SR-IOV, resources of a given physical device may be mapped to individual VMs. In SIOV, a more customizable and granular approach is adopted, with SIOV enabling the flexible definition of virtual devices (VDEV) that may be mapped to a respective VM. High performance I/O devices may include a large number of command/completion interfaces for efficient multiplexing/demultiplexing of I/O. SIOV platforms may enable the assignment of such interfaces to isolated domains at a fine granularity. An SIOV architecture defines the granularity of sharing of a device or device resource as an “Assignable Device Interface” (ADI). Each ADI instance on the device may encompass the set of resources on the device that are allocated by software to support the direct-path operations for a virtual device. For instance, resources on a device associated with work submission, execution, and completion operations may implement device backend resources (e.g., command/status registers, on-device queues, references to in-memory queues, local memory on the device, or any other device-specific internal constructs). An ADI may identify a set (e.g., all or a subset of the total device resources, or even a combination of resources of two or more discrete devices) of device backend resources that are allocated, configured, and organized as an isolated unit, forming the unit of device sharing. The type and number of backend resources grouped to compose an ADI may be device specific. Each SIOV ADI on a device function may use the same PCIe Requester ID (Bus/Device/Function (BDF) number) corresponding to the device's PCIe Function. Process Address Space Identifiers (PASID) may be used to distinguish upstream memory transactions performed for different ADIs and to convey the address space targeted by the transaction.

ADIs form the unit of assignment and isolation for devices and are composed by software to form virtual devices (VDEVs). A Virtual Device Composition Module (VDCM) is responsible for managing virtual device instances. For instance, for direct-path accesses, a VMM may map the direct-path accesses from the guest directly onto the provisioned ADIs for the VDEV. For intercepted-path accesses, the VMM identifies the intercepted-path accesses from the guest and forwards them to VDCM for emulation. VDCM emulates the intercepted accesses to the VDEV. In some cases, the VDCM may access the underlying physical device corresponding to the ADI (e.g., to read a corresponding device register, identify ADI status, configure the ADI's PASID, etc.). Virtual device composition, among other advantages, enables increased sharing scalability and flexibility at lower hardware cost and complexity. SIOV utilizes software to define and share device resources with different address domains using different VDEV abstractions. For example, application processes may access a device using system calls and VMs may access a device using virtual device interfaces. Virtual device composition can also enable dynamic mapping of VDEVs to device resources, allowing a VMM to over-provision device resources to VMs. For instance, the resources of one or multiple physical devices may be mapped to a given VDEV. VDEVs may thus be defined to achieve particular goals of the system. As an example, in a data center with various physical machines containing different generations (e.g., versions) of the same I/O device, VDEVs may be defined to present the same VDEV capabilities irrespective of the different generations of physical I/O devices used in the VDEV definitions. Such a solution may allow the same guest OS image with a particular VDEV driver to be deployed or migrated to various combinations or deployments of physical machines.

During operation, upstream memory requests from all ADIs (within respective VDEV mapped to various VMs or containers) may be tagged with the Requester ID of the device (or device function) hosting the ADIs. Requests from different ADIs of the device function may be distinguished using a Process Address Space Identifier (PASID). The Requester ID and/or the PASID may be used to identify (e.g., in a TLP prefix) the address space associated with the request. Accordingly, when assigning an ADI to an address domain (e.g., VM, container, or process), the ADI may be configured with a unique PASID of the address domain and its memory requests may be tagged with the PASID value (e.g., in a PASID TLP Prefix).

As introduced above, in SIOV, a VDEV may serve as the abstraction through which a shared physical device is exposed to guest software. In some implementations, a VDEV may be exposed to a guest OS as a virtual PCI Express device. A VDEV may be defined to possess virtual resources such as virtual Requester ID, virtual configuration space registers, virtual memory BARs, virtual MSI-X table, etc. Each VDEV may be mapped to or formed from one or more ADIs (corresponding to various devices or device functions). The ADIs backing a VDEV may belong to the same physical function or allocated across multiple functions (e.g., to support device fault tolerance or load balancing).

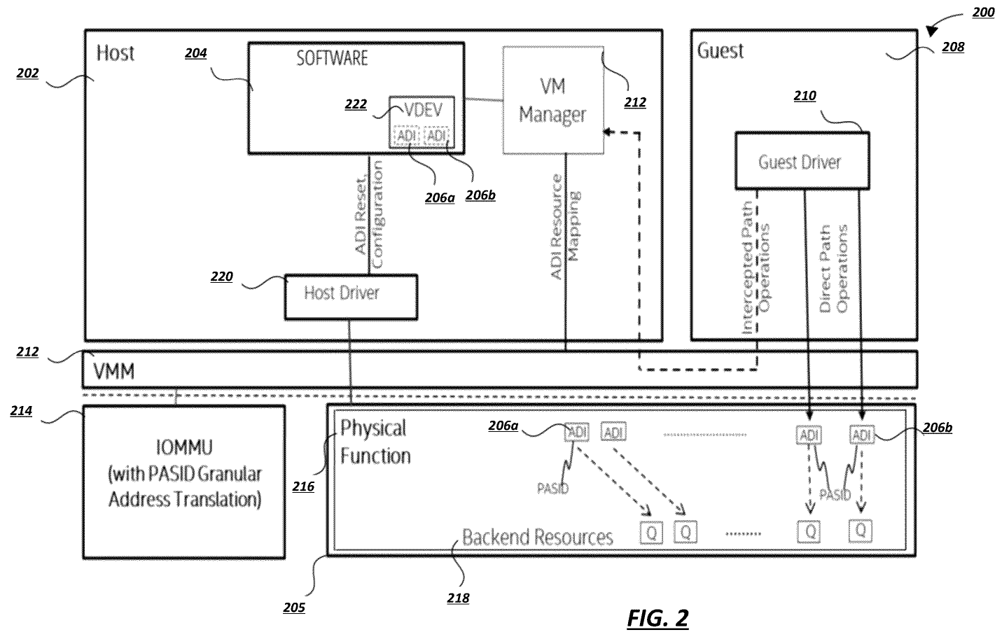

FIG. 2 is a simplified block diagram 200 illustrating an implementation of an example operating environment 200 that supports the SIOV architecture to virtualize one or more devices (e.g., 205) such as component devices on a given computing platform or other packages, such as accelerators, I/O devices, network processing devices, etc. In this example, the operating environment may include a host OS 202, a guest OS 208, a VMM 212, an input/output memory management unit (IOMMU) 214, and one or more devices (e.g., 205) possessing I/O resources capable of being virtualized (e.g., based on SR-IOV or SIOV, etc.). Host OS 202, guest OS 208, and/or VMM 212 may execute on the host hardware 104. Host OS 202 may include a host driver 220 and guest OS 208 may include a guest driver 210.

As shown, in conventional embodiments of SIOV environments, host OS 202 may include software 204 which may compose a virtual device (VDEV) 222 for the guest OS 208. In some embodiments, VDEV 222 may include virtual capability registers configured to expose device (or “device-specific”) capabilities to one or more components of operating environment 200. In various embodiments, virtual capability registers may be accessed by guest driver 210 of the device 205 to determine device capabilities associated with VDEV 222. The VDEV 222 may include one or more assignable device interfaces (ADIs) (also referred to as “assignable interfaces”), including an ADI 206a and an ADI 206b. In some embodiments, an ADI may be assigned, for instance, by mapping the ADIs 206a-206b into a MMIO space of the VDEV 222. An ADI generally refers to the set of backend resources 218 of the device 205 that are allocated, configured, and organized as an isolated unit, forming the unit of device sharing of the device 205. The type and number of backend resources 218 grouped to compose a given ADI 206a, 206b, may be specific to the device 205. An ADI 206a, 206b may be associated with a device context, rather than with specific device resources. As another example, the backend resources 218 of the ADIs 206a-206b may include one or more shared work queues. A repository (not pictured) or other data structure may store a plurality of different ADIs and the respective attributes of each ADI.

For example, if the device 205 is a network controller, the ADIs 206a-206b may provide backend resources 218 that include transmit queues and receive queues associated with a virtual switch interface. As another example, if the device 205 is a storage device, the ADIs 206a-206b may provide backend resources 218 that include command queues and completion queues associated with a storage namespace. As yet another example, if the device 205 is a graphics processing unit (GPU) or other processor device (XPU), the ADIs 206a-206b may provide backend resources 218 that include dynamically created graphics or compute contexts, among other example devices and ADIs.

The IOMMU 214 may be configured to perform memory management operations, including address translations between virtual memory spaces and physical memory. As shown, the IOMMU 214 may support translations at the Process Address Space ID (PASID) level. Generally, a PASID may be assigned to each of a plurality of processes executing on the host hardware 104 (e.g., processes associated with guest OS 208 and/or VMs). Doing so enables sharing of the device 205 across multiple processes while providing each process a complete virtual address space.

In some implementations, software 204 may implement a VDCM. In some instances, a distinct instance of software 204 (or a VDCM) may be provided for each device which is to be virtualized. For instance, a VDCM may be implemented as a device-specific component responsible for composing and implementing VDEV instances 222 using one or more ADIs allocated, for instance, by a host driver 220. The VDCM implements software-based virtualization of intercepted-path operations and arranges for direct-path operations to be submitted directly to the backing ADIs. The host driver 220 may be loaded DCMs may be implemented and packaged by device vendors in a various ways, such as user-space modules or libraries that are installed as part of the host driver or a. In other implementations, the VDCM may be a kernel module. If implemented as a library, the VDCM may be statically or dynamically linked with the hypervisor-specific virtual machine resource manager responsible for creating and managing VM resources. If implemented in the host kernel, the VDCM can be part of the host driver. The host driver is loaded and executed as part of the host OS or hypervisor software. The host driver may report support for SIOV (and/or SR-IOV) to system software through the driver interface. In addition to standard device driver functionality, the host driver 220 may implement software interfaces (e.g., as defined by the host OS or hypervisor infrastructure) to support enumeration, configuration, instantiation, and management of ADIs. The host driver may be responsible for configuring the ADIs, including aspects such as PASID identity, Interrupt Message Storage entries, MMIO register resources for direct-path access to the ADI, and any device-specific resources, among other example functionality and features.

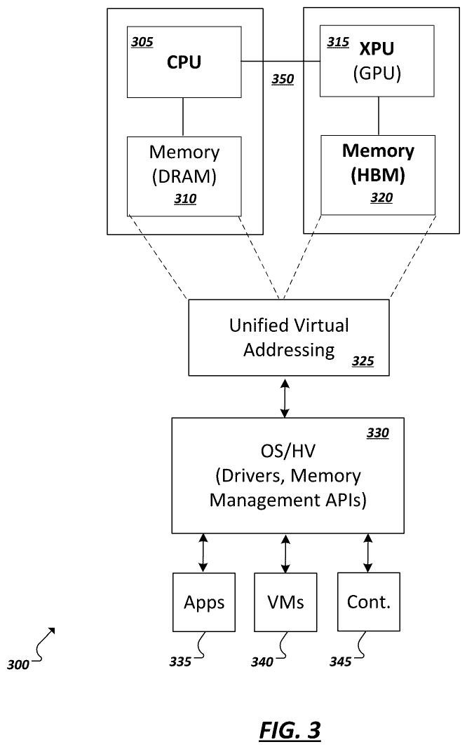

Modern computing platforms increasingly rely on heterogeneous architectures that integrate general-purpose CPUs with specialized accelerators such as GPUs, machine learning accelerators, tensor processing units, network processors, and other XPUs. These architectures may additionally leverage different memory technologies, such as a mix of Dynamic Random-Access Memory (DRAM) (e.g., associated with CPUs), High Bandwidth Memory (HBM) (e.g., associated with GPUs and AI accelerators), among other examples. Each type of memory may have distinct performance characteristics, which make them optimal for specific computational workloads. For instance, DRAM supports lower-latency, random-access patterns ideal for general-purpose computing, while HBM excels in high-throughput, parallelized data access suited for graphics rendering, AI workloads, and analytics, among other examples. Further such heterogeneous architectures and their respective hardware elements may be utilized within virtualization architectures, such as discussed above, allowing workloads of a given application to make use of these various components. For instance, turning to FIG. 3, a simplified block diagram 300 is shown illustrating an example system including a CPU device 305 with associated DRAM memory 310 interconnected with a GPU device 315 with associated HBM memory 320. The interconnection (e.g., a die-to-die interconnect using a protocol such as CXL, UCIe, NVLink, PCIe, etc.) between the CPU 305 and GPU 315 may permit the CPU 305 to access (e.g., through the GPU) data in the HBM memory 320 and, likewise, the GPU 315 to access data in the DRAM memory 310, among other examples. Unified virtual addressing 325 may be implemented across these heterogeneous CPU (DRAM-based) and XPU/GPU (HBM-based) memory architectures interconnected via the die-to-die interconnect 350 as managed by the operating system or hypervisor (e.g., 330) of the system to assist in implementing resource allocation for various applications 335, VMs 340, containers 345, etc. within the system.

However, despite the theoretical performance benefits of combining these XPU and memory technologies, efficiently managing data locality can be a challenge. For instance, data residing in memory suboptimal to the compute clement accessing it can significantly degrade performance, increase latency, and reduce overall system efficiency. Some systems may attempt to address this issue through static or manual memory allocation strategies, which often fail to adapt dynamically to varying computational demands, particularly in heterogeneous XPU workloads. Such static allocations result in frequent performance penalties due to inefficient memory access patterns, increased latencies, and underutilized memory resources, among other example issues.

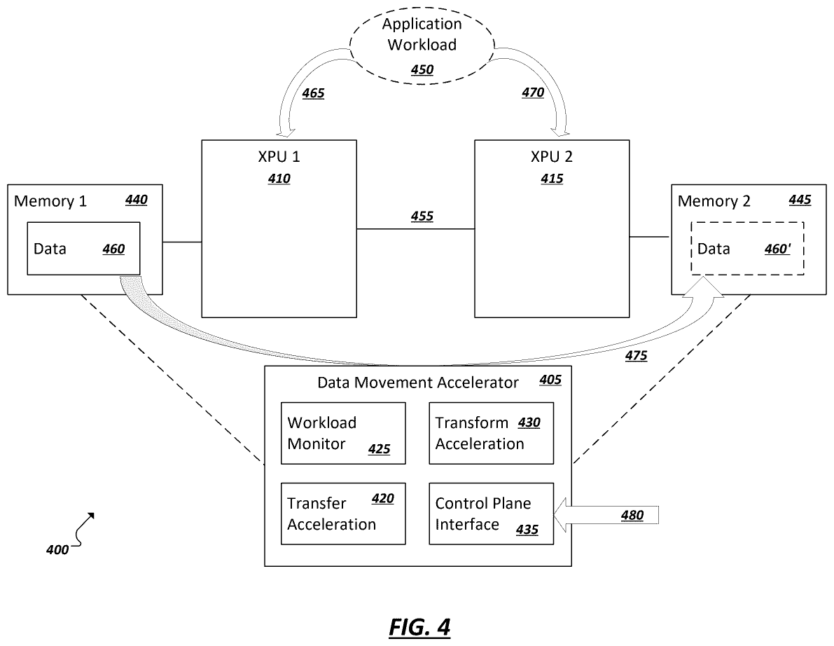

In some implementations, an improved system may be provided which includes an improved hardware accelerator with logic to dynamically adjust memory locality, ensuring data placement aligns optimally with a computing element used by the application in a given workload, among other examples. For instance, turning to the simplified block diagram 400 of FIG. 4, an example data movement accelerator 405 may be provided and may interface with one or more XPUs 410, 415 of heterogeneous types. The data movement accelerator 405 may be used to more efficiently harness the promising potential of heterogenous XPU architectures (e.g., combining the capabilities of the various different XPUs (e.g., CPUs, GPUs, tensor or matrix processors (TPUs), ASICs, accelerators, etc.)) to implement an adaptive system that allows for dynamic management of data locality and structures according to real-time usage patterns. Computing systems may struggle with static data allocation schemes, leading to scenarios where GPUs frequently access data stored in latency-oriented DRAM, or CPUs inadvertently process large parallel data sets from HBM designed primarily for bandwidth-intensive tasks, among other examples. Such suboptimal data allocation may adversely impact computational performance, energy efficiency, and system responsiveness, among other example issues.

In some implementations, the data movement accelerator 405 may include hardware (e.g., 420) to accelerate data accesses (e.g., direct memory access (DMA)) between components of the system. The data movement accelerator 405 may include workload monitoring circuitry 425 to intelligently monitor memory access patterns within the system, predict computational demand, and automatically orchestrate data relocation between different memory blocks within the system based on this monitoring. The data movement accelerator 405 can aim to ensure optimal data locality and memory access patterns, directly enhancing performance. Additionally, an example data movement accelerator 405 may include data transformation circuitry 430 to transform data structures in connection with reallocation (e.g., 475) of data (e.g., 460) from one memory (e.g., 440) to another (e.g., 445) to align the data with memory-specific characteristics of the new memory destination (e.g., 445). As an example, the data transformation logic 430 of the data movement accelerator 405 may convert tree-based database structures suitable for CPU-side DRAM into linear arrays optimized for GPU-side HBM or transforming floating-point data types for AI inference acceleration, among a variety of other data transform examples. Accordingly, the data movement accelerator 405 may significantly boost computational efficiency and throughput of the system and resolve critical performance bottlenecks associated with static and non-adaptive memory management through a proactive, intelligent approach, thereby providing substantial gains in computational performance, energy efficiency, and overall system quality, among other example benefits.

Continuing with the example of FIG. 4, a given task, process, or other workload 450 of an application, VM, container, or program may be assigned to be executed or otherwise performed using one of the XPUs (e.g., 410, 415) in the system. Assigning or allocating the task 450 to a given one of the XPUs may be based on one or a combination of factors including the nature of the task (e.g., whether it would benefit from particular hardware acceleration or processing capabilities of a particular XPU or is more appropriate for general purpose processing (e.g., on a CPU XPU)), the capacity of the XPU and or its associated memory (e.g., 440, 445), the geographic location of the XPU, a load balancing or other allocation algorithm or scheme employed on the system, among other example factors. In some cases, a workload 450 may be allocated to and completed using a single XPU. In other cases, it may be advantageous to use multiple XPUs to complete the workload 450, with execution of the workload migrating (e.g., 465, 470) between two or more different XPUs (e.g., 410, 415) before the workload is completed. Performance of a given workload 450 may involve corresponding data (e.g., 460) that is to be accessed, operated upon, or otherwise consumed during performance of the workload 450. As noted above, in traditional systems, migrating the performance of a workload between two or more XPUs (e.g., interconnected by an interconnect 455) may involve a static allocation of the subject data (e.g., 460) to the memory (e.g., 440) of one of the multiple XPUs (e.g., 410) that is anticipated to be used to perform the workload (e.g., based on a prediction that the attached XPU (e.g., 410) is going to perform more accesses of the data 460, is the primary XPU that will be used, among other example factors).

In an improved implementation, where an application workload 450 involving data 460 (e.g., a data structure, database, data collection, etc.) is to be performed using multiple different XPU devices (e.g., 410, 415), a data movement accelerator 405 may be utilized, which interfaces with the XPUs 410, 415 (and/or their associated memory elements (e.g., 440, 445)) to identify hot (or frequently used or accessed) data paths, transform corresponding data structures 460 (or select portions of the data structure 460), and relocate 475 the transformed data 460′ opportunistically from the memory (e.g., 440) of one of the XPUs (e.g., 410) to the memory (e.g., 445) of another one of the XPUs (e.g., 415) to enhance computational performance and resource efficiency. Such intelligent reallocation of memory and provision of improved memory locality may improve the available system throughput and responsiveness in applications such as large machine learning model training, AI inferencing, analytics, and other applications involving large data workloads, among other example use cases.

The data movement accelerator 405 in some implementations, may be implemented as an enhanced DMA engine equipped with circuitry to perform data transformations and relocations between different memories (e.g., DRAM and HBM). The workload monitor hardware 425 may monitor the memories 440, 445 and track memory access patterns, identify hot data paths, and trigger appropriate actions based on these observed patterns and trends. In some implementations, the data movement accelerator 405 may leverage high-speed interfaces (e.g., implemented through a die-to-die interconnect 455) between the heterogeneous XPUs 410, 415 (e.g., a CPU die and a GPU die) to perform efficient data transfers and low-latency communication. In some implementations, unified virtual addressing may be supported across the heterogeneous memory domains, enabling coherent virtual-to-physical address translations.

Additionally, the system may include enhanced OS or hypervisor capabilities to manage memory allocations, updates to virtual address mappings, and execution of coherent data updates. Memory management APIs may be provided in some implementations to allow applications to provide hints and explicit control (e.g., 480) over memory transformation and migration operations (e.g., to access a control plane interface 435 and define settings for the transformation and/or transfer of data between heterogeneous memory domains using the data movement accelerator 405). Further, kernel-level services may be provided, such as the integration of kernel-level memory-to-memory transformation services that can execute offline copies and real-time updates, ensuring data coherence and minimal application disruption. To assist in the proper definition and identification of data transformations to be applied by the data movement accelerator 405, additional software logic can be provided that is capable of determining the appropriate structural transformations, such as datatype conversions for AI workloads or restructuring database formats optimized for target memory characteristics, among other examples. Together, these hardware and software enhancements enable the efficient and dynamic alignment of data locality, significantly improving computational performance, responsiveness, and overall system efficiency.

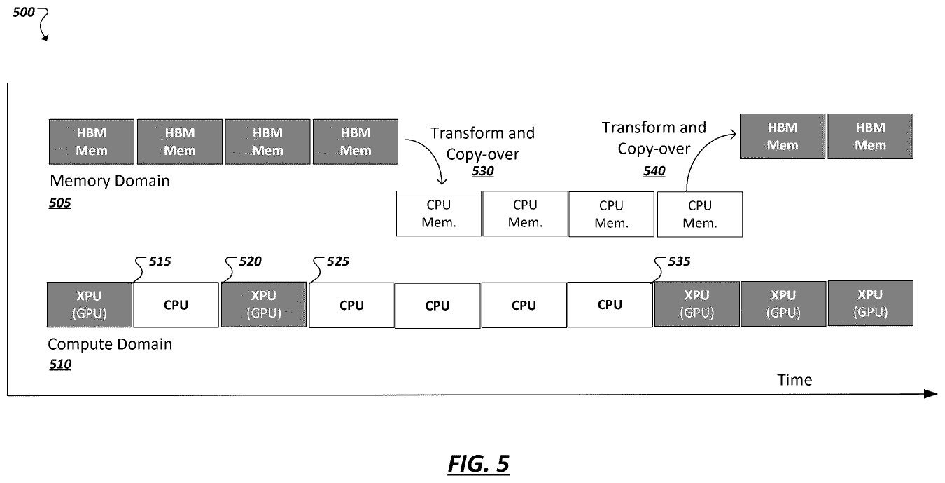

The diagram 500 of FIG. 5 is an illustration of an example dynamic memory transformation and data migration between HBM (GPU memory) and DRAM (CPU memory) domains based on compute resource utilization as detected using an example data movement accelerator. As illustrated in this example, data to be accessed within the memory domain 505 during a given application task or workload is initially loaded into HBM memory and is initially accessed by an XPU (GPU) in the compute domain 510 associated with the HBM memory. As performance of the task progresses (e.g., in time, cycles, etc.), performance of the workload may be reallocated (e.g., at 515) from the GPU to a CPU (which is associated with different CPU memory in the memory domain 505) for a time or given sub-task, etc. Such workload shifting may be at the direction of an OS or hypervisor of the system governing the application's performance. In this example, performance of the workload may shift multiple times (e.g., 515, 520, 525) without revealing (to the data movement accelerator) a pattern, trend, or threshold use that triggers reallocation of the subject data from the HBM memory to the memory local to the CPU. However, in this example, at a later time (e.g., 530) in the execution of the workload, the data movement accelerator may determine that the data should be shifted from the HBM to the CPU's DRAM memory and perform a transformation and copy-over of the data (at 530). At a later time (e.g., 540), for instance, based on another transition from the CPU to the GPU (e.g., at 535) the data movement accelerator may determine another opportunity to return the data back to the HBM to make the data more local to the GPU (e.g., which may be predicted to make more frequent or extensive use of the data in the subsequent performance of the workload) through a retransformation and copy-over (at 540) of the data to the HBM. Such transformations and migrations of the data can take place dynamically over the performance of the workload and may include migration of the data between two or more heterogeneous memories corresponding to two or more heterogeneous processors, among other examples.

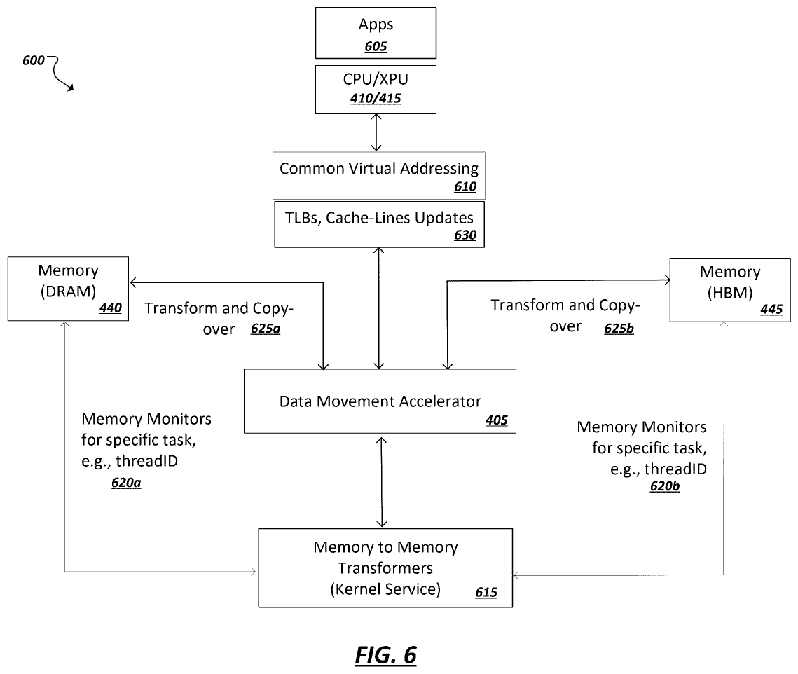

Turning to FIG. 6, a simplified block diagram 600 is shown illustrating an example system architecture (e.g., similar to that shown in the example of FIG. 3) including an example data movement accelerator 405. The data movement accelerator 405 may be used to implement a structured framework to dynamically manage and optimize memory locality in heterogeneous computing platforms, for instance, integrating CPU (DRAM) and GPU/XPU (HBM) memory domains. The data movement accelerator 405 may coordinate data transformation and migration based on real-time computational demands and memory access patterns. For instance, in this example, various applications (e.g., 605) running on XPUs (e.g., 410, 415, etc.) of the system may rely on a unified virtual addressing mechanism 610, facilitating coherent memory access across disparate memory technologies associated with the heterogenous XPUs. In some implementations, the data management accelerator 405 may interface with and receive information from hardware monitors (e.g., outside of or integrated within the data management accelerator 405) to specifically track (at 620a-b) memory access patterns (e.g., by tasks or thread IDs). With this information, the data management accelerator 405 may identify hot paths and initiate optimized memory movements (at 625a-b). Upon identifying frequently accessed data, the data movement accelerator 405 may perform intelligent data structure transformations, such as restructuring databases from tree-based formats suitable for CPU-side DRAM into linear, parallel-access-friendly formats optimized for GPU-side HBM, or performing datatype conversions beneficial for a particular XPU (e.g., datatype advantageous for executing an AI workloads using a GPU, TPU, or machine learning accelerator), among other examples. The data migrations and transformations may be coordinated, in some implementations, via kernel-level services (e.g., 615) to ensure coherence, synchronization, and minimal disruption to running applications. After transformations, common virtual addressing (including updates to TLBs and cache-line mappings 630) ensures seamless memory access redirection to the newly transformed data locations. This automated, adaptive process continually optimizes the system's memory usage, significantly enhancing computational performance, efficiency, and responsiveness, among other example features.

A system enhanced with a data movement accelerator may find the dynamical memory locality management provided through the data movement accelerator to be beneficial in a variety of applications and use cases and the nature of the application can be considered in determining how and under what conditions (e.g., which usage thresholds or forecasts) data transformations and migrations should be carried out by the data movement accelerator. For instance, AI and machine learning workloads may leverage the value of enhanced dynamic memory locality and data transformation provided through a data movement accelerator. For instance, in the case of AI and machine learning workloads, a data movement accelerator may be utilized to assist in dynamically moving inference data (e.g., neural network weights and activation tensors) between heterogeneous memories (e.g., DRAM and HBM) based on workload demand, enabling datatype conversions (e.g., from FP32-to-INT8) to accelerate GPU computation and thereby enhance inference performance, reduces latency, and improves energy efficiency during intensive AI processing. As another example, real-time analytics and database operations may also benefit, for instance, through the optimization of data structures through the data movement accelerator's transformation logic (e.g., converting tree-based or hashed-indexed tables for CPU into contiguous arrays suitable for GPU parallel processing) to accelerate frequent join, fork, and aggregate operations across heterogeneous memory architectures to boost query throughput, reduces response times, and improves overall database responsiveness in mixed XPU analytic workloads. As yet another example, virtualized and containerized computing platforms (e.g., implemented in cloud, edge, or fog computing systems) may utilize the functionality of an example data movement accelerator to automatically reallocate data to heterogenous memories and accommodate varying VM and container demands, intelligently adapting data locality to match real-time computational requirements and thereby improving resource utilization, enhancing isolation between workloads, and ensuring higher quality-of-service (QoS) for cloud applications running diverse and dynamic computational tasks, among other example advantages and use cases.

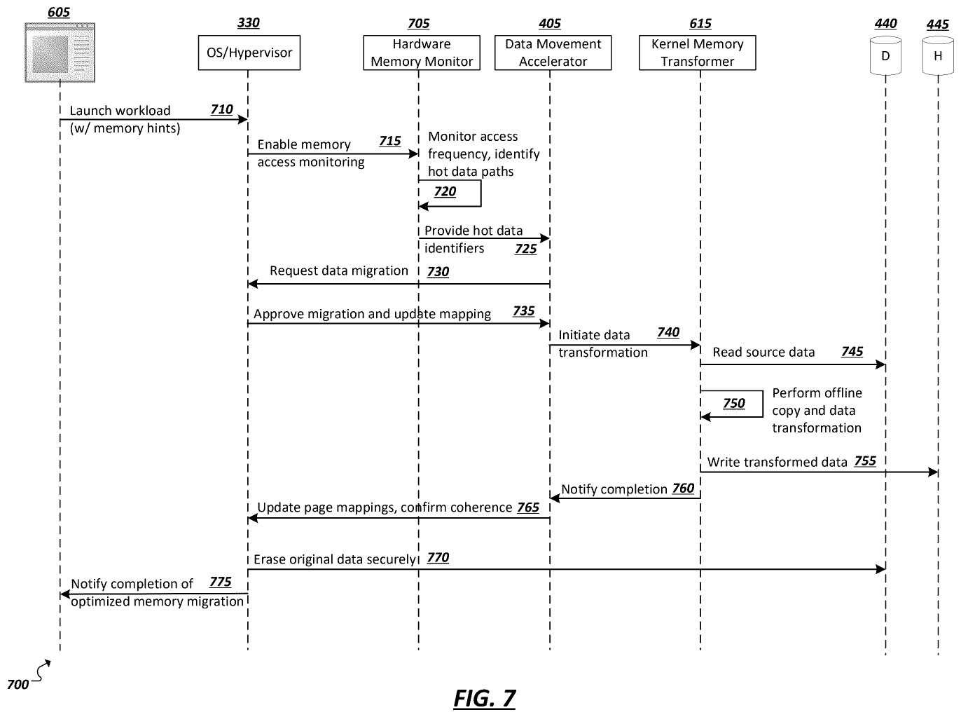

Turning to FIG. 7, a flow diagram 700 is shown illustrating the example use of an example data movement accelerator 405 to perform an example data transformation and transfer between two heterogenous memories (e.g., 440, 445) to dynamically assist in management memory locality for a given application. For instance, an application 605 may launch a (computational) workload 710 and indicate the workload to an associated OS or hypervisor 330 (e.g., via OS/hypervisor APIs). In some instances, the application 605 may provide memory hints to indicate recommendations for where to store associated data (e.g., initially), the XPU types that may be advantageously used to perform the workload, conditions or policies to consider when triggering migration or determining memory locality for the workload, among other example information. In this manner, the application 605 may provide or maintain an element of control or input to how the data movement accelerator will handle its data. Based on the identified workload, the OS/hypervisor 330 may activate 715 hardware memory monitors (e.g., 705) to track memory access patterns in real-time. The memory monitors 705 may be hardware incorporated on the data movement accelerator 405 or external to the data movement accelerator 405 (e.g., provided on the memory elements, an associated memory manager block, the XPUs themselves, a system management subsystem, or other another example utility). Memory monitoring circuitry 705 may continuously assess 720 data access frequencies and detect hot data paths that are candidates for locality optimization.

When hot data paths (e.g., memory address ranges that have been or are predicted to be accessed by a particular XPU) are identified through the memory monitoring 720, corresponding information may be identified by or provided to 725 the data movement accelerator 405 (e.g., identifiers such as a thread ID corresponding to the associated workload, memory address ranges of the data (in its current location), an identifier of the XPU that is accessing the data, etc.). The data movement accelerator 405 may determine from this information that a corresponding data migration should be triggered (e.g., based on the hot data path information indicating that a threshold level of use of given data by a given XPU is anticipated (e.g., based on a hint or policy associated with the application 605)). Accordingly, the data movement accelerator 405 may send a request or indication 730 to the OS/hypervisor 330 that the data migration should take place. The OS/hypervisor 330 may approve the migration, update associated virtual-to-physical address mappings 735 (e.g., TLBs and page tables), and ensures that subsequent memory accesses point correctly to the new locations. Upon receiving an approval indication 735 from the OS/hypervisor 330, the data movement accelerator 405 may initiate the data transformation 740. For instance, the data movement accelerator may trigger kernel-level services responsible for detailed data transformations, such as datatype conversions (FP32 to INT8 for AI applications) or structural modifications (database indexing). Kernel services may read data 745 from the source memory 440 (e.g., a DRAM for CPU-oriented structures), perform necessary transformations 750, and migrate data 755 efficiently to the target memory 445 (e.g., a HBM for GPU-oriented formats). Upon completion, the kernel services 615 may notify 760 the data movement accelerator, which then confirms data coherence 765. The OS/hypervisor 330 securely erases data 770 from the original location (e.g., 440), ensuring no stale data persists, maintaining memory isolation. Finally, the OS/hypervisor 330 notifies 775 the application 605 that memory migration and transformation have completed successfully, enabling the workload to benefit immediately from improved memory locality. This automated, adaptive process repeats iteratively as workloads evolve, which may result in multiple instances of hot data paths being identified, which trigger data migrations and associated transformations to continuously enhance computational performance and resource efficiency, among other example benefits and implementations.

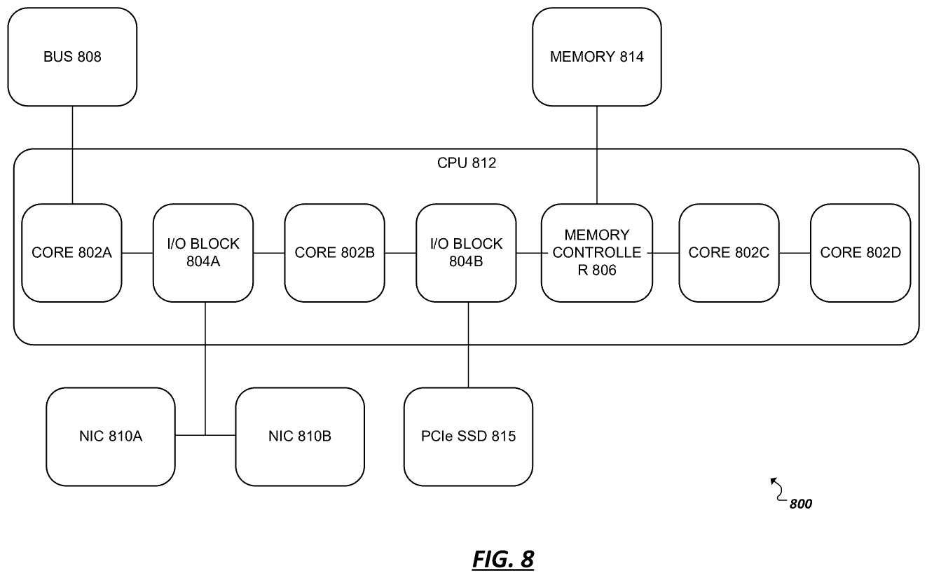

Note that the apparatus, methods, and systems described above may be implemented in any electronic device or system as aforementioned. As a specific illustration, FIG. 8 provides an exemplary implementation of a processing device such as one that may be included in a network interface device. It should be appreciated that other processor architectures may be provided to implement the functionality and processing of requests by an example network interface device, including the implementation of the example network interface device components and functionality discussed above. Further, while the examples discussed above focus on improvements to an Ethernet subsystem and links compliant with an Ethernet-based protocol, it should be appreciated that the principles discussed herein are protocol agnostic and may be applied to interconnects based on a variety of other technologies, such as PCIe, CXL, UCIe, CCIX, Infinity Fabric, among other examples.

Referring to FIG. 8, a block diagram 800 is shown of an example data processor device (e.g., a central processing unit (CPU)) 812 coupled to various other components of a platform in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores-cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing clement operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware, or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: a first interface to couple to a first memory, where the first memory is associated with a first processor device; a second interface to couple to a second memory, where the second memory is associated with a second processor device; monitoring circuitry to: identify accesses to the first memory by the second processor device in association with an application workload to be performed in part on the first processor device and in part on the second processor device, where data to be processed during performance of the application workload is stored on the first memory; and determine a pattern of access of the data in the first memory by the second processor device based on the accesses; and memory transfer circuitry to: transform the data from a first form to a second form; and transfer the data in the second form to the second memory based on the pattern of access.

Example 2 includes the subject matter of example 1, where the data is to be transformed from the first form to the second form and transferred to the second memory based on a policy associated with the application workload, and the apparatus further includes a programming interface to receive information to identify the policy.

Example 3 includes the subject matter of any one of examples 1-2, where the first memory uses a first memory technology and the second memory uses a different second memory technology, and the data is to be transformed to adapt the data to the second memory technology.

Example 4 includes the subject matter of example 3, where the first memory technology includes dynamic random-access memory (DRAM) and the second memory technology includes high bandwidth memory (HBM).

Example 5 includes the subject matter of any one of examples 3-4, where the first processor device includes a first processor architecture and the second processor device includes a second processor architecture.

Example 6 includes the subject matter of example 5, where the first processor architecture includes a central processing unit (CPU) architecture and the second processor architecture includes a processor architecture other than a CPU architecture.

Example 7 includes the subject matter of any one of examples 1-6, where the data in the first form is stored in the first memory in a first portion of performance of the application workload, the data in the second form is stored in the second memory in a second portion of the performance of the application workload.

Example 8 includes the subject matter of example 7, where the monitoring circuitry is further to determine a second pattern of access of the data in the second portion of the performance of the application workload, and the memory transfer circuitry is to transform the data from the second form to the first form and transfer the data in the first form back to the first memory based on the second pattern of access.

Example 9 includes the subject matter of any one of examples 7-8, where the first processor device and the second processor device access the data from the first memory during the first portion of the performance of the application workload to operate upon the data.

Example 10 includes the subject matter of any one of examples 1-9, where the pattern of access indicates a threshold amount of accesses of the data by the second processor device observed or predicted by the monitoring circuitry.

Example 11 includes the subject matter of any one of examples 1-10, where the data is transformed from the first form to the second form to at least one of transform a data type of the data or modify a data structure of the data.

Example 12 is a method including: identifying an application workload performed on data by a plurality of processor devices, where the data is stored in a first memory associated with a first processor device in the plurality of processor devices, a second memory is associated with a second processor device in the plurality of processor devices, and the plurality of processor devices include heterogeneous processor architectures; monitoring accesses of the data from the first memory by the plurality of processor devices; determining an access pattern from the accesses of the data; triggering a transformation of the data from a first form to a second form based on the access pattern, where the first form corresponds to a first memory technology associated with one of the first memory or the first processor device and the second form corresponds to a different second memory technology associated with one of the second memory or the second processor device; and transferring the data in the second form to the second memory based on the access pattern.

Example 13 includes the subject matter of example 12, where the access pattern indicates that the second processor device is predicted to use the data more frequently than the first processor device.

Example 14 includes the subject matter of any one of examples 12-13, further including: monitoring of accesses to the data in the second memory by the plurality of processor devices to determine a second access pattern; triggering transformation of the data from the second form to the first form based on the second access pattern; and transferring the data in the first form to the first memory based on the second access pattern.

Example 15 includes the subject matter of any one of examples 12-14, where the first memory technology includes dynamic random-access memory (DRAM) and the second memory technology includes high bandwidth memory (HBM).

Example 16 includes the subject matter of any one of examples 12-15, where the first processor device includes a first processor architecture and the second processor device includes a second processor architecture.

Example 17 includes the subject matter of example 6, where the first processor architecture includes a central processing unit (CPU) architecture and the second processor architecture includes a processor architecture other than a CPU architecture.

Example 18 includes the subject matter of any one of examples 12-17, where the data in the first form is stored in the first memory in a first portion of performance of the application workload, the data in the second form is stored in the second memory in a second portion of the performance of the application workload.

Example 19 includes the subject matter of example 18, where the monitoring circuitry is further to determine a second pattern of access of the data in the second portion of the performance of the application workload, and the memory transfer circuitry is to transform the data from the second form to the first form and transfer the data in the first form back to the first memory based on the second pattern of access.

Example 20 includes the subject matter of any one of examples 18-19, where the first processor device and the second processor device access the data from the first memory during the first portion of the performance of the application workload to operate upon the data.

Example 21 includes the subject matter of any one of examples 12-20, where the pattern of access indicates a threshold amount of accesses of the data by the second processor device observed or predicted by the monitoring circuitry.

Example 22 includes the subject matter of any one of examples 12-21, where the data is transformed from the first form to the second form to at least one of transform a data type of the data or modify a data structure of the data.

Example 23 is a system including means to perform the method of any one of examples 12-22.

Example 24 includes the subject matter of example 23, where the means includes a non-transitory machine-readable storage medium with instructions stored thereon, the instructions executable by a machine to cause the machine to perform at least a portion of the method of any one of examples 12-22.

Example 25 is a system including: a data locality subsystem including: one or more memory monitors to: identify an application workload performed on data by a plurality of processor devices, where the data is stored in a first memory associated with a first processor device in the plurality of processor devices, a second memory is associated with a second processor device in the plurality of processor devices, where the first memory includes a first memory technology and the second memory includes a different second memory technology; monitor accesses of the data from the first memory by the plurality of processor devices; and determine an access pattern from the accesses of the data, where the access pattern indicates an amount of accesses of the data by the second processor device; a data transformer to transform the data from a first form to a second form based on the access pattern; and a data migrator to transfer the data in the second form to the second memory based on the pattern of access.

Example 26 includes the subject matter of example 25, further including: the first processor device; the first memory; the second processor device; and the second memory.

Example 27 includes the subject matter of any one of examples 25-26, where the data locality subsystem includes a data movement accelerator circuitry to implement two or more of: the one or more memory monitors, the data transformer, or the data migrator.

Example 28 includes the subject matter of any one of examples 25-26, where the data transformer include a kernel service.

Example 29 includes the subject matter of any one of examples 25-28, where the plurality of processor devices include heterogeneous processor architectures.

Example 30 includes the subject matter of example 25, where the memory monitor includes circuitry of a memory manager block associated with the first memory.

Example 31 includes the subject matter of any one of examples 25-30, where the data is to be transformed from the first form to the second form and transferred to the second memory based on a policy associated with the application workload, and the system further includes a programming interface to receive information to identify the policy.

Example 32 includes the subject matter of any one of examples 25-31, where the first memory technology includes dynamic random-access memory (DRAM) and the second memory technology includes high bandwidth memory (HBM).

Example 33 includes the subject matter of any one of examples 25-32, where the first processor device includes a first processor architecture and the second processor device includes a second processor architecture.

Example 34 includes the subject matter of example 33, where the first processor architecture includes a central processing unit (CPU) architecture and the second processor architecture includes a processor architecture other than a CPU architecture.

Example 35 includes the subject matter of any one of examples 25-34, where the data in the first form is stored in the first memory in a first portion of performance of the application workload, the data in the second form is stored in the second memory in a second portion of the performance of the application workload.

Example 36 includes the subject matter of example 35, where the monitoring circuitry is further to determine a second pattern of access of the data in the second portion of the performance of the application workload, and the memory transfer circuitry is to transform the data from the second form to the first form and transfer the data in the first form back to the first memory based on the second pattern of access.

Example 37 includes the subject matter of any one of examples 35-36, where the first processor device and the second processor device access the data from the first memory during the first portion of the performance of the application workload to operate upon the data.

Example 38 includes the subject matter of any one of examples 25-37, where the pattern of access indicates a threshold amount of accesses of the data by the second processor device observed or predicted by the monitoring circuitry.

Example 39 includes the subject matter of any one of examples 25-38, where the data is transformed from the first form to the second form to at least one of transform a data type of the data or modify a data structure of the data.

Example 40 includes the subject matter of any one of examples 25-39, where the application workload includes an machine learning inferencing workload.

Example 41 is a system including: a first processor device; a first memory associated with the first processor device; a second processor device; the second memory associated with the second processor device; and a data locality subsystem including: monitoring circuitry to: identify accesses to the first memory by the second processor device in association with an application workload to be performed in part on the first processor device and in part on the second processor device, where data to be processed during performance of the application workload is stored on the first memory; and memory transfer circuitry to: transform the data from a first form to a second form; and transfer the data in the second form to the second memory based on the accesses.

Example 42 includes the subject matter of example 41, where the data locality subsystem includes a hardware accelerator including the monitoring circuitry and the memory transfer circuitry.

Example 43 includes the subject matter of any one of examples 41-42, where transformation of the data from the first form to a second form includes use of a kernel service.

Example 44 includes the subject matter of any one of examples 41-43, where the plurality of processor devices include heterogeneous processor architectures.

Example 45 includes the subject matter of any one of examples 41-44, where the monitoring circuitry is to determine a pattern of access of the data in the first memory by the second processor device based on the accesses and the data is transformed and transferred based on the pattern of access.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a first interface to couple to a first memory, wherein the first memory is associated with a first processor device;
a second interface to couple to a second memory, wherein the second memory is associated with a second processor device;
monitoring circuitry to:
identify accesses to the first memory by the second processor device in association with an application workload to be performed in part on the first processor device and in part on the second processor device, wherein data to be processed during performance of the application workload is stored on the first memory; and
memory transfer circuitry to:
transform the data from a first form to a second form; and
transfer the data in the second form to the second memory based on the accesses.

2. The apparatus of claim 1, wherein the data is to be transformed from the first form to the second form and transferred to the second memory based on a policy associated with the application workload, and the apparatus further comprises a programming interface to receive information to identify the policy.

3. The apparatus of claim 1, wherein the first memory uses a first memory technology and the second memory uses a different second memory technology, and the data is to be transformed to adapt the data to the second memory technology.

4. The apparatus of claim 3, wherein the first memory technology comprises dynamic random-access memory (DRAM) and the second memory technology comprises high bandwidth memory (HBM).

5. The apparatus of claim 3, wherein the first processor device comprises a first processor architecture and the second processor device comprises a second processor architecture.

6. The apparatus of claim 5, wherein the first processor architecture comprises a central processing unit (CPU) architecture and the second processor architecture comprises a processor architecture other than a CPU architecture.

7. The apparatus of claim 1, wherein the data in the first form is stored in the first memory in a first portion of performance of the application workload, the data in the second form is stored in the second memory in a second portion of the performance of the application workload.

8. The apparatus of claim 7, wherein the monitoring circuitry is further to determine an amount of accesses of the data in the second portion of the performance of the application workload, and the memory transfer circuitry is to transform the data from the second form to the first form and transfer the data in the first form back to the first memory based on the amount of accesses.

9. The apparatus of claim 7, wherein the first processor device and the second processor device access the data from the first memory during the first portion of the performance of the application workload to operate upon the data.

10. The apparatus of claim 1, wherein the monitoring circuitry is to determine a pattern of access of the data in the first memory by the second processor device based on the accesses.

11. The apparatus of claim 10, wherein the pattern of access indicates a threshold amount of accesses of the data by the second processor device.

12. The apparatus of claim 1, wherein the data is transformed from the first form to the second form to at least one of transform a data type of the data or modify a data structure of the data.

13. A method comprising:
identifying an application workload performed on data by a plurality of processor devices, wherein the data is stored in a first memory associated with a first processor device in the plurality of processor devices, a second memory is associated with a second processor device in the plurality of processor devices, and the plurality of processor devices comprise heterogeneous processor architectures;
monitoring accesses of the data from the first memory by the plurality of processor devices;
determining an access pattern from the accesses of the data;
triggering a transformation of the data from a first form to a second form based on the access pattern, wherein the first form corresponds to a first memory technology associated with one of the first memory or the first processor device and the second form corresponds to a different second memory technology associated with one of the second memory or the second processor device; and
transferring the data in the second form to the second memory based on the access pattern.

14. The method of claim 13, wherein the access pattern indicates that the second processor device is predicted to use the data more frequently than the first processor device.

15. The method of claim 13, further comprising:
monitoring of accesses to the data in the second memory by the plurality of processor devices to determine a second access pattern;
triggering transformation of the data from the second form to the first form based on the second access pattern; and
transferring the data in the first form to the first memory based on the second access pattern.

16. A system comprising:
a first processor device;
a first memory associated with the first processor device;
a second processor device;
the second memory associated with the second processor device; and
a data locality subsystem comprising:
monitoring circuitry to:
identify accesses to the first memory by the second processor device in association with an application workload to be performed in part on the first processor device and in part on the second processor device, wherein data to be processed during performance of the application workload is stored on the first memory; and
memory transfer circuitry to:
transform the data from a first form to a second form; and
transfer the data in the second form to the second memory based on the accesses.

17. The system of claim 15, wherein the data locality subsystem comprises a hardware accelerator comprising the monitoring circuitry and the memory transfer circuitry.

18. The system of claim 15, wherein transformation of the data from the first form to a second form comprises use of a kernel service.

19. The system of claim 15, wherein the plurality of processor devices comprise heterogeneous processor architectures.

20. The system of claim 15, wherein the monitoring circuitry is to determine a pattern of access of the data in the first memory by the second processor device based on the accesses and the data is transformed and transferred based on the pattern of access.
